(19) United States
(12) Patent Application Publication
(10) Pub. No.: US 2021/0158678 A1
(43) Pub. Date: May 27, 2021

(54) ALARM ACTIVATION SYSTEM

(71) Applicant: Carrier Corporation, Palm Beach Gardens, FL (US)

(72) Inventor: Jairo Munoz Rodriguez, Barcelona (ES)

(21) Appl. No.: 16/951,620

(22) Filed: Nov. 18, 2020

(30) Foreign Application Priority Data
Nov. 22, 2019 (EP) 19383035.3

(51) Int. Cl. G08B 17/02

(52) U.S. Cl. CPC G08B 17/02

(57) ABSTRACT

A fire alarm activation system 1 includes: a sensing device 2 configured to detect removal of a fire extinguisher 4, and a manual call point 3 in communication with the sensing device 2. Detection of a removal of the extinguisher by the sensing device 2 will trigger an alarm condition of the manual call point 3. The alarm condition of the manual call point 3 can also be triggered manually by a user.

### FOREIGN PRIORITY

This application claims priority to European Patent Application No. 19383035.3, filed Nov. 22, 2019, and all the benefits accruing therefrom under 35 U.S.C. § 119, the contents of which in its entirety are herein incorporated by reference.

### TECHNICAL FIELD

The present invention relates to an activation system for a fire alarm, and to a related method of activating a fire alarm.

### BACKGROUND

In many jurisdictions fire alarm systems are provided with manual call points allowing for manual fire alarm activation via human intervention. Typically some form of electromechanical device is used allowing for a person to sound an alarm, such as an evacuation alarm in a building. Often these manual call points are used in conjunction with automatic fire alarm systems in which there is a possibility for automatic activation using sensors such as heat detectors and smoke detectors. Automated fire suppression systems can be provided within the same system. The manual call points can be wired into the fire alarm system or in some cases may be wirelessly connected.

In accordance with some regulations, manual call points are typically located in the vicinity of a fire extinguisher. In the event of a fire an operator may use the fire extinguisher to attempt to extinguish or suppress the fire. In order to alert others to the possible threat of fire the operator should activate the manual call point before taking the fire extinguisher. This raises an alarm which allows people in the area to respond appropriately to the danger such as by evacuating the building.

As call points are an important safety feature then it is typical for regulations to set requirements for their appearance, operation and placement, as well as setting out methods of testing to ensure that call points have the required performance before they are placed on the market. For example, European Standard EN 54 part 11 specifies the requirements and methods of test for manual call points in fire detection and fire alarm systems in and around buildings, and EN 54 part 18 specifies requirements, test methods and performance criteria for input/output devices connected to a transmission path of fire detection and fire alarm systems. These European Standards contain provisions similar to those in other jurisdictions where manual call points are used, defining different required elements of the manual call point as well as how they should function.

Within this document the following terminology is used, which is consistent with the terminology of EN 54-11 and EN 54-18 for the sake of convenience. It will be appreciated that the terms used should apply in the same way to equivalent structural and functional elements of manual call points intended for operation in other jurisdictions, i.e. meeting alternative regulatory requirements where the terminology may differ.

As referenced herein, an alarm condition is the condition of the manual call point after an operating element thereof has been activated. The operating element is a mechanical and electrical switching element; the part of the manual call point that initiates the alarm signal when operated. Typical manual call points also include a frangible element, which is a component made of glass or having the appearance of glass (e.g. “plastic glass”) and which after receiving a blow or pressure, is physically broken or is visibly displaced by change of position and remains in that condition until replaced or reset. The frangible element gives protection against unintentional operation, i.e. by resisting relatively small forces, and is a deterrent against misuse. The breaking or apparent breaking (e.g. visible displacement) of the frangible element is designed to be necessary in order to activate the operating element, which typically includes a part visible to the user through the frangible element.

Manual call points can be provided with a non-resettable frangible element, i.e. a frangible element that needs to be replaced after the activation of the manual call point, in order for the manual call point to be able to return to a normal condition. Alternatively there may be a resettable frangible element that can be returned to its original position without replacement, in order for the manual call point to be able to return to the normal condition also without replacement of the frangible element. The normal condition is a condition in which the frangible element is undamaged and the manual call point is operating without giving an alarm or fault signal.

As noted above, the alarm condition is the condition after activation of the operating element. Typically the transfer from the normal condition to the alarm condition is easily recognisable by the change in the appearance of the operating face, such as by the breakage or apparent breakage of the frangible element and/or by movement of the operating element.

The manual call point may have a size and shape consistent with the requirements of applicable regulations. For example, the size and shape may be as required by EN 54-11. Thus, the manual call point may have a cuboid housing with a rectangular front face, such as a square front face with the housing comprising an outer wall enclosing all parts of the manual call point. The housing may be arranged to mount to a flat vertical surface, e.g. a wall of a building, with the front face sitting forward of the vertical surface by at least 10 mm or at least 15 mm. The operating element may be accessible and/or visible through the front face, such as through a window that may be provided by the frangible element. The front face may have a height and/or width be in the range 85 mm to 135 mm.

The above discussion describes the general requirements of standard manual call points which are activated by manual operation of the operating element. As noted previously, in situations where an operator uses an extinguisher to tackle a fire it is important that the operator first activates the nearby manual call point before taking the extinguisher. However during a fire the operator may forget to activate the manual call point before taking the extinguisher. This can delay the communication of the fire risk and thus increase the likelihood of dangerous consequences of the fire. For example evacuation procedures may be delayed leading to greater chance of injuries.

### SUMMARY

Viewed from a first aspect, the present invention provides a fire alarm activation system comprising: a sensing device configured to detect removal of a fire extinguisher from a normal position, and a manual call point in communication with the sensing device, wherein detection of removal of the fire extinguisher by the sensing device will trigger an alarm condition of the call point, and wherein the manual call point is also for manual triggering of the alarm condition by a user.

With this fire alarm activation system advantages are provided in relation to a more reliable activation of a fire alarm. The connection to the manual call point advantageously enables the fire extinguisher to become a supervised element of the fire alarm system. The sensing device enables the alarm condition of the call point to be triggered when the fire extinguisher is removed without the need for the user to manually activate the call point. Therefore even if the user of a fire extinguisher forgets to activate the call point the alarm condition will still be activated by the action of removing the fire extinguisher, increasing the probability that the presence of the fire is communicated.

The fire alarm activation system may comprise the fire extinguisher. The normal position of the fire extinguisher is a position of the fire extinguisher when not in use. The normal position may include being seated in a housing or mounted to a wall. The user may remove the extinguisher from the normal position when it is desired to use the extinguisher. A sensing device is configured to detect the removal of the extinguisher from the normal position, and may comprise any device capable of detecting the removal of the extinguisher such as a mechanical switch and/or an optical sensor. The sensing device may comprise more than one switch/sensor for redundancy.

The manual call point may comprise an operating element for manually triggering the alarm condition, such as an operating element in accordance with previously discussed regulations. Upon detecting the removal of the extinguisher, the sensing device may trigger the alarm condition of the call point by activating the operating element of the call point, or by otherwise breaking or closing an operating circuit that will trigger the alarm condition.

In existing manual call points the operating element is often an electromechanical switch device such as a micro-switch or other switch device in which physical movement of the operating element brings electrical contacts into or out of engagement. In the present system the operating element of the call point may be a device which can be activated by a signal received by the call point from the sensing device. The signal may indicate that the extinguisher was removed. The operating element of the manual call point may be operable by manual activation of the call point and automatically by the sensing device.

Alternatively the manual call point may comprise an operating element which can be activated manually and an operating circuit which can be activated by the sensing device. In this case, the operating circuit for automatic operation via the sensing device may comprise electrical components, whereas the operating element for manual operation should comprise at least some mechanical elements, for example in accordance with applicable regulatory requirements. In some implementations the sensing device is connected to an input of the manual call point, which may be a supervised input. A supervised input ensures the sensing device is always connected to the loop. Integrating an input, e.g. a supervised input, in the manual call point allows the supervision of the use of the fire extinguisher with a single device. The sensing device may receive electrical power from the manual call point.

Once the alarm condition of the manual call point has been triggered the manual call point may communicate the alarm condition to a fire alarm control panel by sending a signal indicative of the alarm condition to the fire alarm control panel. The manual call point may be arranged to communicate with the fire alarm control panel wirelessly and/or via a wired connection. The fire alarm activation system may comprise the fire alarm control panel together with the sensing device and the manual call point. In response to receiving the signal from the manual call point indicating that the alarm condition has been triggered, the fire alarm control panel may activate an alarm. The alarm may be any kind of alarm such as audible and/or visual. The alarm is to advise of the potential presence of a fire so that appropriate actions may be taken by people perceiving the alarm. In some instances the fire alarm control panel may take another action such as activating a fire suppression system in response to receiving the signal, e.g. a sprinkler system.

It is advantageous to communicate the removal of the extinguisher to the fire alarm control panel via the manual call point rather than via a direct connection between the sensing device and the fire alarm control panel. As noted previously, regulations dictate that manual call points should be located near to extinguishers. Therefore integrating the input from the sensing device with the nearby manual call point provides benefits including a reduction in product and installation costs, as well as removing the need to increase the number of devices in the loop to supervise the extinguisher. The present system can create additional inputs in existing manual call points thus further reducing installation and product costs.

The fire activation system may comprise a second manual call point and a second sensing device, wherein the second manual call point is in communication with the second sensing device and the fire alarm control panel. It will be appreciated that the any number of call points and sensing devices may be used, for example in a network distributed within a building and connected to a common fire alarm control panel. The second sensing device may trigger an alarm condition of the second manual call point in response to detection of removal of an extinguisher. The second manual call point may communicate the alarm condition to the fire alarm control panel. The fire alarm control panel may be able to identify which manual call point of the manual call points is in the alarm condition. The fire alarm control panel may display this information on a display, thus allowing an operator to quickly identify the location at which the fire extinguisher was taken and/or which manual call point was manually operated. This enables rapid location of the fire to minimise damage and promptly contain the fire.

The fire alarm activation system may be provided for a building, and thus examples extend to a building comprising a fire alarm activation system as in the first aspect and optionally including other features as discussed above.

Viewed from a second aspect, the invention provides a method of activating a fire alarm comprising using the fire alarm activation system as described above in relation to the first aspect. The fire alarm activation system may include any other feature as discussed above.

The method may include triggering the alarm condition of the manual call point by causing the sensing device to detect removal of an extinguisher. The method may comprise removing an extinguisher from a normal position to cause the sensing device to trigger the alarm condition of the manual call point.

### BRIEF DESCRIPTION OF THE DRAWINGS

Certain preferred embodiments of the present invention will now be described, by way of example only, with reference to the following drawings, in which:

FIG. 1 is a diagram of a fire alarm activation system.

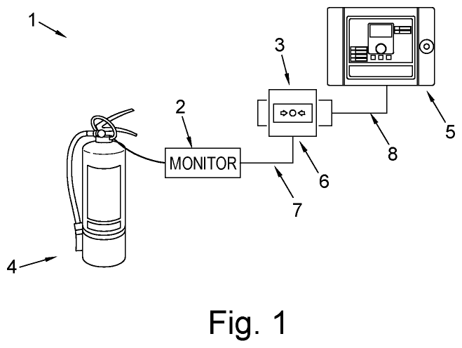

### DETAILED DESCRIPTION

As shown in the FIGURE a fire alarm activation system 1 includes a sensing device 2, a manual call point 3, an extinguisher 4, and a fire alarm control panel 5.

The sensing device 2 is configured to detect removal of the extinguisher 4 from a normal position of the extinguisher.

The manual call point 3 is in communication with the sensing device 2 via connection 7, which is a wired connection. The sensing device 2 is connected to an input 6 in the manual call point 3, which is a supervised input in this example.

The manual call point 3 is in communication with the fire alarm control panel 5 via connection 8. The manual call point 3 is configured to send a signal to the fire alarm control panel 5 when an alarm condition of the manual call point 3 has been triggered. The fire alarm control panel is configured to activate an alarm in response to receiving the signal from the manual call point 3.

Although not shown in the FIGURE(s), the fire alarm activation system 1 may comprise a plurality of manual call points 3, a plurality of sensing devices 2, and/or a plurality of extinguishers 4. Each of the plurality of manual call points 3 is in communication with the fire alarm control panel 5. When at least one of the plurality of sensing devices 2 detects removal of one of the plurality of extinguishers 4 thus triggering an alarm condition in the associated manual call point 3, the fire alarm control panel 5 is configured to determine which of the plurality of manual call points 3 is in the alarm condition. The fire alarm control panel 5 may include a display for indicating which manual call point 3 has been triggered, which enables responders to quickly locate the possible fire.

In the event of a fire or a potential fire, the operation of the fire alarm activation system proceeds as follows. An operator may remove an extinguisher 4 from a normal position, which is a position of the extinguisher 4 when not in use. The sensing device 2 detects removal of the extinguisher 4 and sends a corresponding signal through connection 7 to the manual call point 3 via the supervised input 6. The signal causes the manual call point 3 to change from a normal condition in which the call point 3 is operating without giving an alarm or fault signal, to an alarm condition after an operating circuit or operating element thereof has been activated. The signal therefore acts to trigger the alarm condition of the manual call point 3. The manual call point 3 may also change from the normal condition to the alarm condition as a result of manual operation of the call point by an operator.

The manual call point 3 then sends a signal to the fire alarm control panel 5 via connection 8 indicating that the alarm condition of the manual call point 3 has been triggered. The fire alarm control panel 5 activates an alarm in response to receiving the signal from the manual call point 3. The alarm, which may be an audio and/or visual alarm, advises of the removal of the extinguisher 4 which thereby indicates the potential presence of a fire. In examples in which there is a plurality of manual call points 3, the fire alarm control panel 5 determines which manual call point 3 is in the alarm condition and displays a corresponding indication.

The system provided herein increases the likelihood of activation of a fire alarm since it is not reliant on the operator of the extinguisher 4 remembering to manually operate the manual call point 3. Additionally, since the sensing device 2 communicates the presence of a fire through a supervised input 6 of an existing manual call point 3 which is typically located near the extinguisher 4, there is a reduced need for additional devices in the loop and therefore a reduction in product and installation costs.

It will be understood that some features described herein, such as a frangible element, are required by regulation such as with reference to EN54-11, and of course all such features must be included for devices intended to be approved under those regulations. However, it should be appreciated that it is not essential to the function of the manual call point described herein, and in particular the function of the operating element and switches, for all such features to be present. Moreover, whilst all features defined in the relevant regulations are in effect essential for a commercial product, this is not the same as what is essential for implementing the present claims. Instead the claims themselves define what is essential in that regard, taking account of the teaching of the remainder of this disclosure.

What is claimed is:

1. A fire alarm activation system, comprising:
a sensing device configured to detect removal of a fire extinguisher from a normal position, and
a manual call point in communication with the sensing device,
wherein detection of removal of the fire extinguisher by the sensing device will trigger an alarm condition of the manual call point, and
wherein the manual call point is also for manual triggering of the alarm condition by a user.

2. A fire alarm activation system as claimed in claim 1, comprising the fire extinguisher.

3. A fire alarm activation system as claimed in claim 1, wherein the sensing device is configured to send a signal indicative of removal of the fire extinguisher to the manual call point to trigger the alarm condition.

4. A fire alarm activation system as claimed in claim 3, wherein the signal is for activating an operating element of the call point to trigger the alarm condition, wherein the operating element is also used for the manual triggering of the alarm condition.

5. A fire alarm activation system as claimed in claim 3, wherein the signal is for activating an operating circuit of the call point to trigger the alarm condition.

6. A fire alarm activation system as claimed in claim 1, wherein the sensing device is connected to a supervised input in the call point.

7. A fire alarm activation system as claimed in claim 1, comprising a fire alarm control panel, wherein the manual call point is configured to send a signal indicative of the alarm condition to the fire alarm control panel when the alarm condition has been triggered.

8. A fire alarm activation system as claimed in claim 7, further comprising a second manual call point and a second sensing device, the second manual call point being in communication with the second sensing device and the fire alarm control panel, and the second sensing device being configured to detect removal of a second fire extinguisher from a normal position.

9. A fire alarm activation system as claimed in claim 8, wherein the fire alarm control panel is configured to determine which manual call point is in an alarm condition.

10. A fire alarm activation system as claimed in claim 1, wherein the sensing device is configured to receive power from the manual call point.

11. A fire alarm activation system as claimed in claim 1, wherein the sensing device comprises a mechanical switch and/or an optical sensor for detecting the removal of the fire extinguisher.

12. A building comprising the fire alarm activation system of claim 1.

13. A method of activating a fire alarm using the fire alarm activation system as claimed in claim 1, the method comprising triggering an alarm condition of a manual call point by causing a sensing device to detect removal of an extinguisher.

14. The method of claim 13, wherein triggering the alarm condition includes removing the extinguisher from a normal position to cause the sensing device to trigger the alarm condition.
